(19) United States
(12) Patent Application Publication
(10) Pub. No.: US 2013/0131918 A1
(43) Pub. Date: May 23, 2013

(54) SYSTEM AND METHOD FOR AN INFORMATION AND ENTERTAINMENT SYSTEM OF A MOTOR VEHICLE

(71) Applicant: GM GLOBAL TECHNOLOGY OPERATIONS LLC, Detroit, MI (US)

(72) Inventor: Uwe Hahne, Buettelborn (DE)

(73) Assignee: GM GLOBAL TECHNOLOGY OPERATIONS LLC, Detroit, MI (US)

(21) Appl. No.: 13/670,521

(22) Filed: Nov. 7, 2012

(30) Foreign Application Priority Data
Nov. 10, 2011 (DE) 10 2011 118 157.5

(51) Int. Cl. G06F 17/00

(52) U.S. Cl. CPC G06F 17/00
USPC 701/36

(57) ABSTRACT

A method for operating an information and entertainment system of a motor vehicle is provided. The method includes providing data for a transmission to at least one additional motor vehicle by means of a communication network. The method includes determining at least one parameter characterizing a traffic situation of the motor vehicle, and classifying a current traffic situation of the motor vehicle, based on the at least one determined parameter. The method includes adapting of a parameter characterizing an availability of the motor vehicle within the communication network as a function of the classified current traffic situation.

### CROSS-REFERENCE TO RELATED APPLICATION

This application claims priority to German Patent Application No. 10 2011 118 157.5, filed Nov. 10, 2011, which is incorporated herein by reference in its entirety.

### TECHNICAL FIELD

The present disclosure relates to a method for operating an information and entertainment system of a motor vehicle, an information and entertainment system for a motor vehicle, a computer program product and a computer-readable medium.

### BACKGROUND

From US 2009/0170434 A1 a method is known for transmitting information that has been formatted for internet publication from a principal vehicle using short range wireless communication components to communicate with a second vehicle. The method includes storing an internet page (blog, social networking page, etc.) or other information formatted for internet publication in the principal vehicle. An introductory signal is transmitted to the second vehicle. A communication link is established between the principal vehicle and the second vehicle using the respective short range wireless communication components. The second vehicle is then queried for authorization to transmit the information and, if given, the information is then transmitted to the second vehicle via the communication link. User-defined categories can be used to identify common interests between users of the two vehicles. The method can be used to share user information with other potentially interested drivers to facilitate human interactions and relationships.

Accordingly, it may be desirable to provide a method for operating an information and entertainment system of a motor vehicle, an information and entertainment system for a motor vehicle, a computer program product and a computer-readable medium, which enable a further improvement of a communication network between motor vehicles. In addition, other objects, desirable features and characteristics will become apparent from the subsequent summary and detailed description, and the appended claims, taken in conjunction with the accompanying drawings and this background.

### SUMMARY

According to one of various aspects of the present disclosure, a method for operating an information and entertainment system of a motor vehicle can comprise the following. A provision of data takes place, wherein the data are provided for a transmission to at least one additional motor vehicle by means of a communication network. In addition, a determining takes place at least of one parameter characterizing a traffic situation of the motor vehicle. Furthermore, a classifying takes place of a current traffic situation of the motor vehicle, based on the at least one determined parameter. Moreover, an adapting takes place of a parameter characterizing an availability of the motor vehicle within the communication network as a function of the classified current traffic situation.

Throughout this disclosure, an availability of the motor vehicle within the communication network is understood in one example to mean that the motor vehicle is available for a data transmission, wherein a data transmission in one example can contain a receiving of data from additional participants of the communication network.

The method according to one exemplary embodiment enables a further improvement of the communication network existing between the motor vehicle and at least one additional motor vehicle. This takes place by the determining of the at least one parameter and the classifying of the current traffic situation of the motor vehicle and the adapting of the parameter characterizing the availability of the motor vehicle within the communication network as a function of the current traffic situation. Thereby, the respective traffic situation for the communication or respectively availability of the motor vehicle within the communication network can be taken into consideration, whereby for example potential hazard situations can be avoided or respectively the operation of the information and entertainment system can be adapted to a further improved extent to the respective user requirements.

In an exemplary embodiment, the determining of the at least one parameter contains a determining of a type and/or a property of a roadway currently being travelled by the motor vehicle.

Furthermore, the determining of the at least one parameter can contain a determining of a number of further road users in the region of the environment of the motor vehicle. Throughout this disclosure, a road user is understood to mean a person or a vehicle who or respectively which is using areas which are open to the general public for traffic purposes, irrespective of whether the person or respectively the vehicle is moving or stationary.

Moreover, the determining of the at least one parameter can contain additionally or alternatively a determining of a current speed and/or of a current position of the motor vehicle.

In addition, the determining of the at least one parameter can contain a determining of current weather conditions in the region of the environment of the motor vehicle.

The said parameters enable the current traffic situation to be classified to as precise an extent as possible and hence a further improved operation of the information and entertainment system.

The determining of the at least one parameter takes place generally by means of data at least of one element of the motor vehicle, selected from the group comprising an electromagnetic sensor, in one example a radar sensor or a lidar sensor, an acoustic sensor, in one example an ultrasonic sensor, an angular rate sensor, in one example a yaw rate sensor, an acceleration sensor, an optical camera, a vehicle-to-vehicle communication device, a vehicle-to-infrastructure communication device and a driver assistance system, in one example a collision avoidance or respectively emergency braking system. The said elements are being provided to an increased extent for motor vehicles, whereby the number of components required for the method can be advantageously reduced.

In an exemplary embodiment of the method, the providing of the data takes place by means of a user input into the information and entertainment system, wherein a user input is understood to mean in one example also an inputting of files into the information and entertainment system. This enables the input in a simple manner of the data which is to be transmitted. In a further embodiment, the data can be inputted into a processing unit arranged outside the motor vehicle, and the providing of the data can take place by means of a transmission of these data from the processing unit to the motor vehicle, in one example to the information and entertainment system. Here, the data can contain information with regard to the motor vehicle and/or with regard to a user of the motor vehicle. For example, characteristics such as cubic capacity, performance, type, year or manufacture and/or equipment can be indicated. Furthermore, in one example data concerning the respective vehicle drivers can be indicated, such as age, name, hobbies, driving style or slogans.

In another exemplary embodiment of the method, it is determined in addition whether at least one additional participant of the communication network is situated in the region of the environment of the motor vehicle. If at least one additional participant is determined, in this embodiment an issuing of a message takes place by means of the information and entertainment system, wherein the message contains information with respect to the at least one additional determined participant. Thereby, the occupants of the motor vehicle, in one example the driver of the motor vehicle can be informed of the presence of additional participants of the network who are situated in communication range of the motor vehicle.

Furthermore, a query can be sent to the at least one additional determined participant for a transmission of the data. If the additional participant authorizes the transmission, at least a portion of the data is transmitted to the additional participant. Thereby, after a completed contact query and authorization, a data transmission can be established between the participants of the communication network.

In addition, it can be ascertained by means of a user input whether a transmission of the data to the additional determined participant takes place or does not occur. Thereby, a user of the motor vehicle, in one example the driver of the motor vehicle, can decide in an advantageous manner to which participants of the communication network the data is transmitted.

In another exemplary embodiment, the data is stored in a user-specific manner. In this embodiment, on starting up the motor vehicle, the data is provided which are associated with a current driver of the motor vehicle. Thereby, data for several users of the motor vehicle can be stored and the data for the respective current driver can be made available to him at the start or respectively during the journey. A current driver can be determined here for example by means of a personalized vehicle key. Furthermore, the current driver can be determined by means of a user input and/or speech recognition. In addition, the current driver can be ascertained by means of a fingerprint scanner and/or by means of an image evaluation of images recorded by an optical camera arranged in the interior of the vehicle.

In another exemplary embodiment, in which in addition data is sent to the motor vehicle from at least one further motor vehicle by means of the communication network, an issuing of the received data takes place or does not occur by means of the information and entertainment system as a function of the classified current traffic situation. Thereby, the traffic safety can be increased, by for example an issuing of the received data not occurring in a traffic situation which was classified as a hazard situation. Furthermore, thereby the issuing of the received data can be adapted to a further improved extent to respective user specifications.

In addition, if data from at least one additional motor vehicle is sent to the motor vehicle by means of the communication network, the parameter characterizing an availability of the motor vehicle within the communication network can be adapted as a function of the received data. In one example, an availability status after a reception and an evaluation of the data can be altered from not available to available, for example when the data were sent from a known motor vehicle. Vice versa, the status can be altered from available to not available, if the sending of the data constitutes an unwanted communication.

The data is generally transmitted here by means of a vehicle-to-vehicle communication device. In one example for this a transmission or respectively receiving frequency are provided in a frequency band which corresponds to a WLAN frequency range. The transmission can take place directly between the participating motor vehicles. Furthermore, it is possible that the transmission takes place with intercalation of at least one additional communication device. Thereby, a communication can also take place over further distances at which a direct communication between the participating motor vehicles is not possible.

The present disclosure relates in addition to an information and entertainment system for a motor vehicle, wherein the information and entertainment system has an input device for the provision of data, wherein the data is provided for a transmission to at least one additional motor vehicle by means of a communication network. In addition, the information and entertainment system has a determining device, which is configured for determining at least one parameter characterizing a traffic situation of the motor vehicle. Furthermore, the information and entertainment system has a classification device, which is configured for classifying a current traffic situation of the motor vehicle based on the at least one determined parameter. Moreover, the information and entertainment system has an adaptation device which is configured for adapting a parameter characterizing an availability of the motor vehicle within the communication network as a function of the classified current traffic situation.

The information and entertainment system according to the present disclosure has the advantages already mentioned in connection with the method according to the present disclosure, which, in order to avoid repetition, are not itemized again at this point.

In addition, the present disclosure relates to a computer program product which, when it is executed on a processing unit of a motor vehicle, instructs the processing unit to carry out the following. The processing unit is instructed for the providing of data, wherein the data is provided for a transmission to at least one additional motor vehicle by means of a communication network. In addition, the processing unit is instructed for determining at least one parameter characterizing a traffic situation of the motor vehicle. Furthermore, the processing unit is instructed for classifying a current traffic situation of the motor vehicle, based on the at least one determined parameter. Moreover, the processing unit is instructed for adapting a parameter characterizing an availability of the motor vehicle within the communication network as a function of the classified current traffic situation.

Furthermore, the application relates to a computer-readable medium, on which a computer program product according to the exemplary embodiment is stored.

The computer program product and the computer-readable medium according to the present disclosure have the advantages already mentioned in connection with the method according to the present disclosure which, in order to avoid repetition, are not itemized again at this point.

In the above-mentioned exemplary embodiments, the motor vehicle is, for example, an automobile or a truck.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a flow diagram of a method for operating an information and entertainment system of a motor vehicle according to an exemplary embodiment of the present disclosure;

FIG. 2 shows a flow diagram of a method for operating an information and entertainment system of a motor vehicle according to another exemplary embodiment of the present disclosure;

FIG. 3 shows a flow diagram of a method for operating an information and entertainment system of a motor vehicle according to another exemplary embodiment of the present disclosure;

FIG. 4 shows an example of a traffic situation in which the method according to the present disclosure can be used; and

FIG. 5 shows an information and entertainment system according to an exemplary embodiment of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

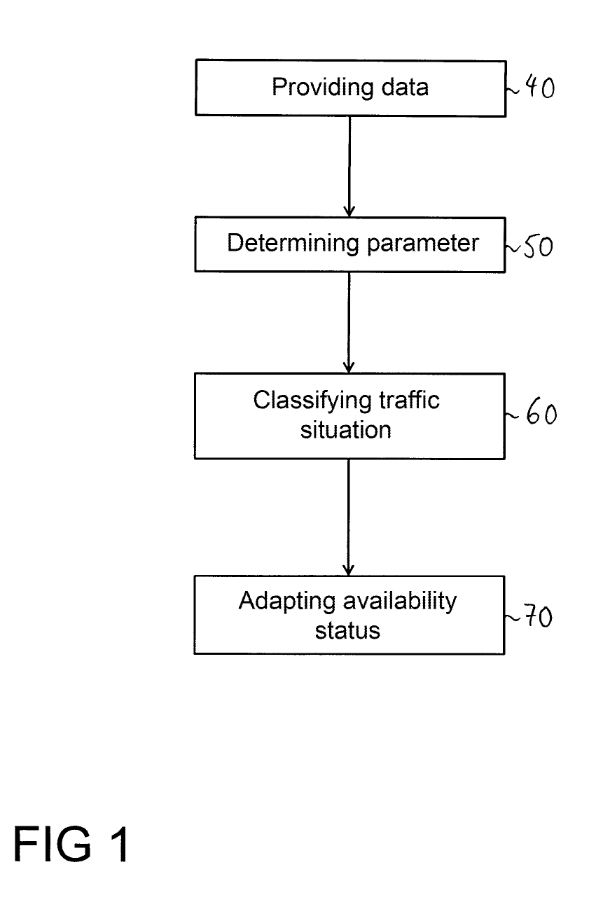

FIG. 1 shows a flow diagram of a method for operating an information and entertainment system of a motor vehicle according to an exemplary embodiment of the present disclosure. The motor vehicle is, for example, an automobile or a truck.

In 40 a providing of data takes place, wherein the data is provided for a transmission to at least one additional motor vehicle by means of a communication network.

The providing of the data takes place for example by means of a user input into the information and entertainment system, wherein a user input is understood to mean in one example also an inputting of files into the information and entertainment system. In addition, the data can be inputted into a processing unit arranged outside the motor vehicle, and the providing of the data can take place by means of a transmission of these data from the processing unit to the motor vehicle, in one example to the information and entertainment system.

The data can contain information here with respect to the motor vehicle and/or with respect to a user of the motor vehicle, in one example with respect to a driver of the motor vehicle.

In 50 a determining takes place of at least one parameter characterizing a traffic situation of the motor vehicle.

The determining of the at least one parameter can contain a determining of a type and/or a condition of a roadway currently being travelled by the motor vehicle. Additionally or alternatively, the determining of the at least one parameter can contain a determining of a number of additional road users in the region of the environment of the motor vehicle and/or of current weather conditions in the region of the environment of the motor vehicle. Furthermore, the determining of the at least one parameter can contain a determining of a current speed and/or of a current position of the motor vehicle.

The determining of the at least one parameter takes place here generally by means of data of at least one element of the motor vehicle, selected from the group comprising an electromagnetic sensor, an acoustic sensor, an angular rate sensor, an acceleration sensor, an optical camera, a vehicle-to-vehicle communication device, a vehicle-to-infrastructure communication device and a driver assistance system.

In 60 a classifying takes place of a current traffic situation of the motor vehicle, based on the at least one determined parameter. The classifying of the current traffic situation can contain in one example a classifying as to the type of roadway which currently being travelled. Furthermore, the current traffic situation can be classified as to whether the motor vehicle is situated inside or outside a closed locality or respectively whether a current speed of the motor vehicle exceeds or falls below a predetermined threshold.

In 70 a parameter characterizing an availability of the motor vehicle within the communication network is adapted as a function of the classified current traffic situation. The parameter here can constitute in one example an availability status for a data transmission, in one example for a reception of data. For example, the parameter can indicate whether the motor vehicle is parked and hence not available or is in operation and hence available.

The adapting of the parameter can be based here on user-defined specifications. For example, the driver of the motor vehicle can define particular road types, particular regions and/or particular speed ranges for which his status is set as being available.

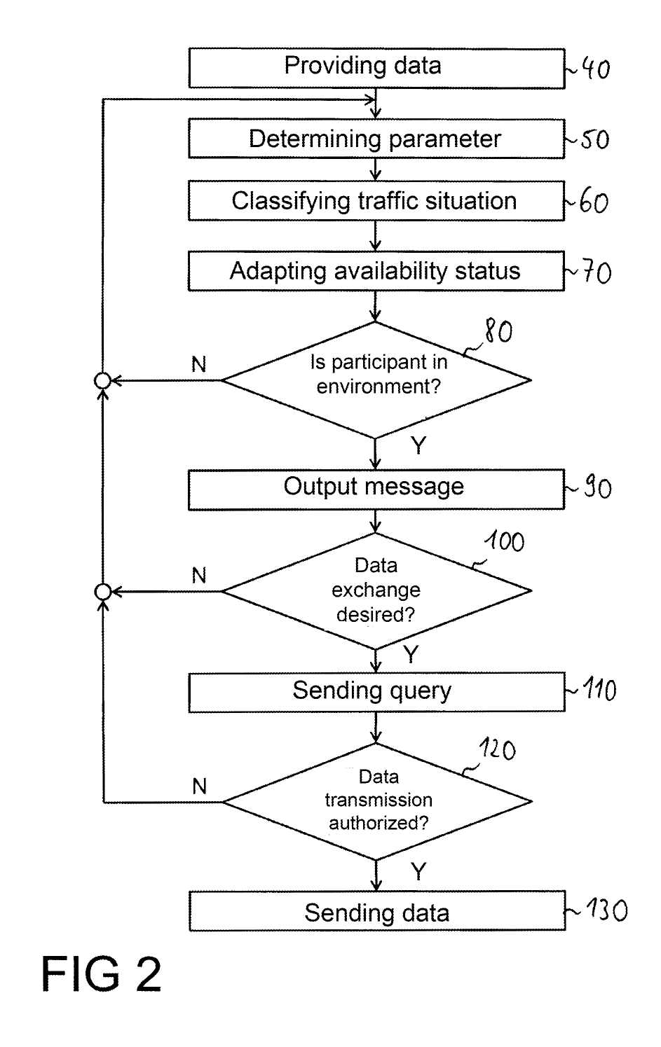

FIG. 2 shows a flow diagram of a method for operating an information and entertainment system of a motor vehicle according to another exemplary embodiment of the present disclosure. The motor vehicle is again for example an automobile or a truck.

In 40 a providing of data takes place for a transmission to at least one additional motor vehicle by means of a communication network. In 50 at least one parameter characterizing a traffic situation of the motor vehicle is determined, and in 60 a current traffic situation of the motor vehicle is classified, based on the at least one determined parameter. In 70 an adapting takes place of a parameter characterizing an availability of the motor vehicle within the communication network as a function of the classified current traffic situation.

The 40, 50, 60 and 70 correspond to the steps 40 to 70 of the exemplary embodiment shown in FIG. 1.

In 80 furthermore it is determined whether at least one additional participant of the communication network is situated in the region of the environment of the motor vehicle. For this, for example, all vehicles can be determined along the route of the motor vehicle which have a network-compatible module.

If no additional participant of the communication network is situated in the region of the environment of the motor vehicle, 40, 50, 60, 70 and 80 are carried out repeatedly in the exemplary embodiment which is shown.

If, on the other hand, in 80 it is determined that at least one further participant of the communication network is situated in the region of the environment of the motor vehicle, in 90 a message is issued by means of the information and entertainment system, wherein the message contains information with respect to the at least one additional determined participant. In one example, an optical and/or acoustic message can be issued. For example, the determined additional participant or respectively the determined additional participants can be displayed on a map.

In 100 it is determined by means of a user input whether a transmission of the data to the at least one additional determined participant takes place or does not occur. For example, the driver of the motor vehicle can select, by means of an input into the information and entertainment system, corresponding motor vehicles to which a data transmission is to take place. Furthermore, in 100, the driver can define which data or respectively which portion of the data are to be transmitted to the at least one additional determined participant.

If the user does not select any additional participant here, to whom a transmission of the data is to take place, 50, 60, 70 and 80 and also, if applicable, 90 and 100 are carried out repeatedly.

If, on the other hand, in 100 at least one additional participant is determined, to whom a transmission of the data is to take place, in 110 a query is sent to this participant for a transmission of the data.

In 120 it is determined whether the additional participant authorizes the transmission of the data.

If no authorization takes place for the data transmission, 50, 60, 70 and 80 and also, if applicable, 90, 100, 110 and 120 are carried out repeatedly.

If, on the other hand, the data transmission is authorized by the additional participant, at least a portion of the provided data or respectively the data defined by the driver in 100 are sent in 130 to the additional participant.

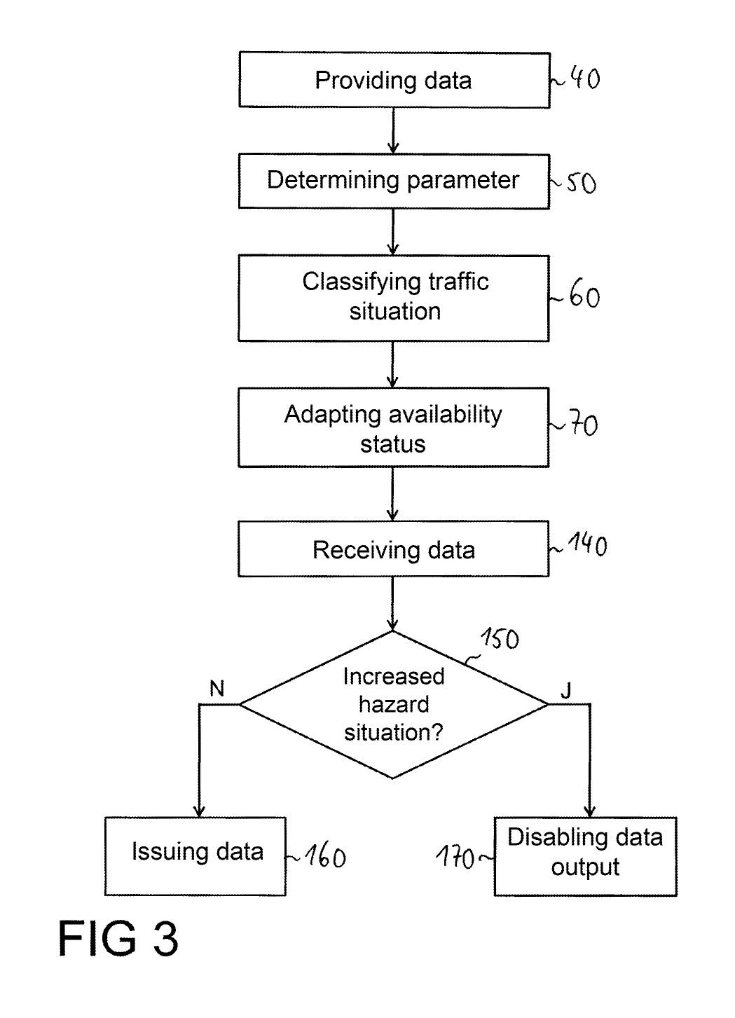

FIG. 3 shows a flow diagram of a method for operating an information and entertainment system of a motor vehicle according to another exemplary embodiment of the present disclosure. The motor vehicle is, for example, an automobile or a truck.

In 40 a provision of data takes place for a transmission to at least one additional motor vehicle by means of a communication network.

Moreover, in 50 at least one parameter characterizing a traffic situation of the motor vehicle is determined and in 60 a current traffic situation of the motor vehicle is classified based on the at least one determined parameter.

In 70 furthermore an adapting takes place of a parameter characterizing an availability of the motor vehicle within the communication network as a function of the classified current traffic situation.

The 40, 50, 60 and 70 correspond here to 40 to 70 of the exemplary embodiment shown in FIG. 1.

In 140 data are sent to the motor vehicle from at least one additional motor vehicle by means of the communication network. In the exemplary embodiment which is shown, the data are transmitted here to the motor vehicle, if the latter appears as being available in the communication network, i.e. if in 70 the parameter was determined as available.

In 150 it is ascertained as a function of the classified current traffic situation, whether an issuing of the received data by means of the information and entertainment system takes place or does not occur. For this, in the exemplary embodiment which is shown, it is determined in 150 whether the classified current traffic situation constitutes an increased hazard situation.

If it is determined in 150 that the current traffic situation does not constitute a hazard situation, in 160 an issuing of the received data takes place by means of the information and entertainment system, for example by means of an optical and/or acoustic output device of the information and entertainment system.

If, on the other hand, it is determined in 150 that the current traffic situation constitutes an increased hazard situation, the issuing of data is disabled, i.e. an issuing of the received data does not occur in this case, as is represented with 170.

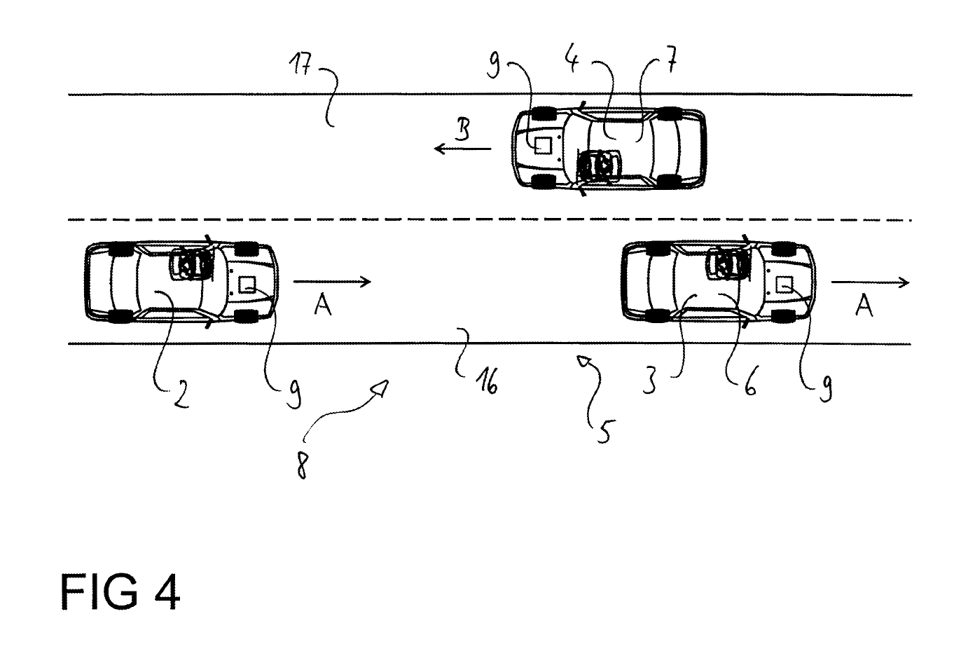

FIG. 4 shows an example of a traffic situation in which the method according to the application can be used, in one example the methods according to the exemplary embodiments shown in FIGS. 1 to 3.

In the traffic situation which is shown, a motor vehicle 2, which in the situation which is shown is an automobile, travels in a direction of travel represented diagrammatically by means of an arrow A on a first lane 16 of a roadway 5. Alongside the lane 16, the roadway 5 has an additional lane 17 in the opposite direction of travel to the lane 16.

In the direction of travel of the motor vehicle 2, in front of the latter an additional motor vehicle 3 is travelling on the lane 16. In addition, a motor vehicle 4 is travelling on the additional lane 17 in a direction of travel represented diagrammatically by means of an arrow B. In the situation which is illustrated, the motor vehicles 3 and 4 are also automobiles and form road users 6 or respectively 7 in an environment 8 of the motor vehicle 2.

The motor vehicle 2 and the additional motor vehicles 3 and 4 have respectively a vehicle-to-vehicle communication device 9, whereby a communication network can be provided between the motor vehicles 2, 3 and 4 and if applicable additional motor vehicles which are not illustrated in further detail. Thereby, in the situation which is shown, a so-called social network can be established between the vehicles and their vehicle drivers.

For this, the driver of the motor vehicle 2 can create in a first step a profile for his vehicle, in which he can allocate to his vehicle a network name, for example in the form of a type designation of the motor vehicle 2, and in addition can indicate, or respectively activate for the system, characteristics, such as for example cubic capacity, performance, type, year of manufacture, equipment and similar. Furthermore, he can indicate data concerning the vehicle drivers, such as age, name, hobbies, driving style, slogans and similar, which are generally selected automatically by a personalized key as soon as the motor vehicle 2 is started up.

Furthermore, if desired, photos relating to the car and to the driver can be activated, which can be communicated to other vehicles and their drivers during a contact. For this, the motor vehicle 2 can become connected during the journey with other vehicles, i.e. in the traffic situation which is shown, in one example with the motor vehicles 3 and 4, via the vehicle-to-vehicle communication devices 9, which are also designated as car2car interfaces, for example in a WLAN frequency band, and the driver can decide which participant in the social vehicle network is permitted to see his own profile with data. For example, this can be only friends or other vehicles in the immediate environment, or only vehicles which are travelling along the route of the motor vehicle 2.

In order to obtain contact with other vehicles or respectively their drivers, a search function can be started, in which for example all the vehicles along the route are shown, which have a network-compatible module and wish to be seen in the social vehicle network. Furthermore, it is also possible to allow all vehicles from particular groups, such as for example taxi drivers, commuters, drivers of a particular make of car, drivers of a particular vehicle type, truck drivers and similar, to be displayed in the network or else on a map, when these have set this as a possibility.

By selecting a vehicle and emitting a contact query, a connection can be established with it and after that, according to the user specification, data of the profile or text messages can be exchanged with the other vehicle, i.e. with the motor vehicles 3 and 4 in the traffic situation which is shown.

If the contact is listed in a list of friends, he can be automatically represented in future on a map in the vehicle 2, for example as a green dot, as soon as he is available or respectively online, typically if the contact is en route.

In addition, queries of other vehicles can be placed onto a so-called ignore list. Thus, one's own vehicle always appears to the other vehicle as being parked or respectively offline, or is invisible to the additional vehicle in the communication network. Also, in one example the driver can decide whether his status is only set to en route when he is situated on particular types of road, such as freeways, for example. In addition, he can designate that he is only set as being en route in particular regions or speed ranges, for example at a speed below about 120 km/h.

In order to reduce interference or respectively distraction of the driver in the case of incoming network queries or text messages, according to a further aspect of the present disclosure, incoming contact queries and text messages from other vehicles are only passed on to the driver or respectively the possibility for issuing short messages is only permitted when on the part of, typically, ambient environment sensors and map information currently no critical traffic situation is detected, wherein a critical traffic situation can exist for example by driving up to a slower vehicle, a change of lane, driving around a bend or approaching a crossroads.

In order to protect privacy, the driver can decide furthermore how precisely the journey position of the motor vehicle 2 is transmitted to other participants. It is possible here that only the status “en route” is communicated. Also, solely the information can be passed on that the motor vehicle 2 is currently moving within a particular region, for example is travelling in the area of a particular town, or on a point along the route. In one example when driving in convoys, on the other hand, the precise position can also be sent to particular selected participants.

In one example on longer journeys, this type of infotainment can help to keep the driver of the motor vehicle 2 occupied and therefore to protect him from tiredness. In addition, it is made possible that the driver can also attend to his social networks during a car journey or respectively the driver is assisted in discovering new networks. This takes place here in an advantageous manner independently of mobile equipment, i.e. independently of equipment which is not permanently connected with the vehicle.

Further details are explained in closer detail in connection with the following figure.

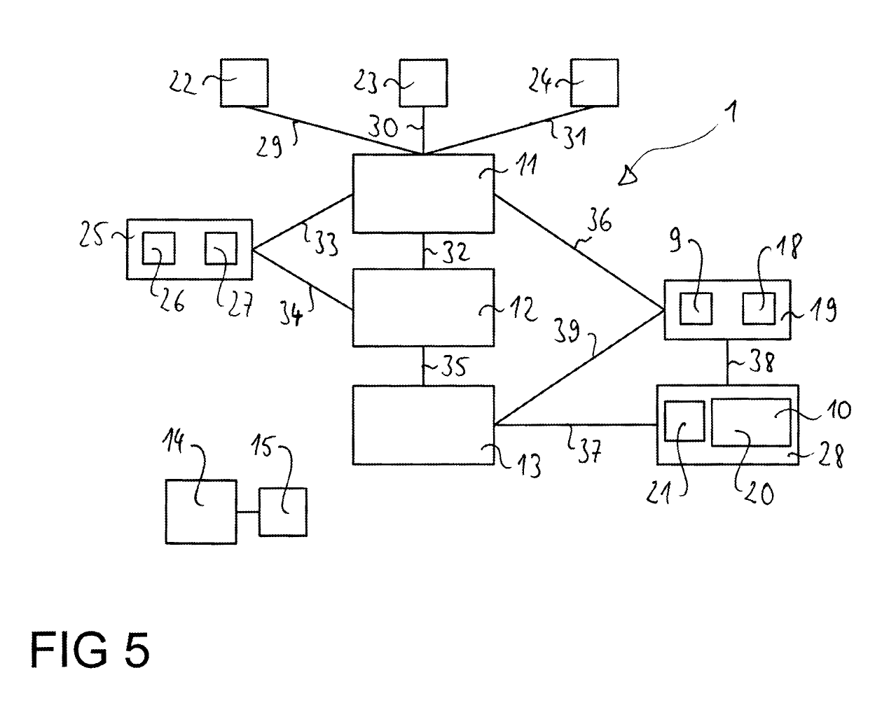

For this, FIG. 5 shows an information and entertainment system 1 for a motor vehicle, not illustrated in further detail in FIG. 5, according to an exemplary embodiment of the present disclosure. The motor vehicle is, for example, an automobile or a truck.

In the exemplary embodiment which is shown, the information and entertainment system 1 has an input device 10 for the providing of data, wherein the data are provided for a transmission to at least one additional motor vehicle by means of a communication network. The input device 10 is a component of an interface 28 and has, for example, a touch screen, which in the exemplary embodiment which is shown forms in addition an output device 20 of the information and entertainment system 1. The interface 28 has, furthermore, a storage device 21 in which the data provided for the transmission can be stored.

In addition, the information and entertainment system 1 has a determining device 11, which is configured for determining at least one parameter characterizing a traffic situation of the motor vehicle.

For this, the determining device 11 in the exemplary embodiment which is shown is connected via a signal line 29 with an electromagnetic sensor 22, for example a radar sensor or a lidar sensor, and via a signal line 30 with an acoustic sensor 23, for example an ultrasonic sensor. Furthermore, the determining device 11 is connected via a signal line 31 with an optical camera 24. Thereby, by means of the said ambient environment sensors a determining of the at least one parameter can take place.

In addition, the determining device 11 is connected via a signal line 33 with a navigation system 25 of the motor vehicle. The navigation system 25 contains here a position determining device 27 and a storage device 26 with map data deposited thereon.

In addition, the determining device 11 is connected via a signal line 36 with a communication unit 19 of the motor vehicle. In the exemplary embodiment which is shown, the communication unit 19 contains a vehicle-to-vehicle communication device 9 and a vehicle-to-infrastructure communication device 18.

In the exemplary embodiment which is shown, the determining of the at least one parameter therefore takes place by means of data of the said elements of the motor vehicle.

Moreover, the information and entertainment system 1 has a classification device 12, which is configured for classifying a current traffic situation of the motor vehicle, based on the at least one determined parameter. For this, the classification device 12 is connected via a signal line 32 with the determining device 11, and via a signal line 34 with the navigation system 25. The classifying of the current traffic situation can therefore take place in one example based on the determined position of the motor vehicle and on the map data de-posited in the storage device 26.

The information and entertainment system 1 has, in addition, an adaptation device 13, which is configured for adapting a parameter characterizing an availability of the motor vehicle within the communication network as a function of the classified current traffic situation. For this, the adaptation device 13 is connected via a signal line 35 with the classification device 12, and via a signal line 37 with the interface 28. Furthermore, the adaptation device 13 is connected via a signal line 39, and the interface 28 is connected via a signal line 38 with the communication unit 19.

In the exemplary embodiment which is shown, the information and entertainment system 1 has, in addition, a processing unit 14 and a computer-readable medium 15, wherein a computer program product is stored on the computer-readable medium 15 which when it is executed on the processing unit 14, instructs the processing unit 14 to carry out the process mentioned in connection with the exemplary embodiments of the method according to the present disclosure, in one example the method of the exemplary embodiments shown in FIGS. 1 to 3, by means of the elements named there. For this, the processing unit 14 is connected, in a manner not illustrated in further detail, directly or indirectly with the corresponding elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A method for operating an information and entertainment system of a motor vehicle, comprising:
providing data for a transmission to at least one further motor vehicle by means of a communication network;
determining at least one parameter characterizing a traffic situation of the motor vehicle;
classifying a current traffic situation of the motor vehicle, based on the at least one determined parameter; and
adapting a parameter characterizing an availability of the motor vehicle within the communication network as a function of the classified current traffic situation.

2. The method according to claim 1, wherein the determining of the at least one parameter further comprises:
determining at least one of a type and a condition of a roadway currently travelled by the motor vehicle.

3. The method according to claim 1, wherein the determining of the at least one parameter further comprises:
determining a number of additional road users in the region of the environment of the motor vehicle

4. The method according to claim 1, wherein the determining of the at least one parameter further comprises:
determining at least one of a current speed and of a current position of the motor vehicle.

5. The method according to claim 1, wherein providing data takes place by means of a user input into the information and entertainment system of the motor vehicle.

6. The method according to claim 5, wherein the data contains information with respect to at least one of the motor vehicle and a user of the motor vehicle.

7. The method according to claim 1, further comprising:
determining whether at least one additional participant of the communication network is situated in the region of the environment of the motor vehicle; and
issuing a message with the information and entertainment system if the at least one additional participant is determined, the message containing information with respect to the at least one additional participant.

8. The method according to claim 7, further comprising:
querying the at least one additional participant for a transmission of the data; and
transmitting at least a portion of the data to the at least one additional participant, if the additional participant authorizes the transmission.

9. The method according to claim 8, further comprising:
ascertaining with a user input coupled to the information and entertainment system whether a transmission of the data to the at least one additional participant takes place or does not occur.

10. The method according to claim 6, wherein the data is stored in a user-specific manner, and on a starting up of the motor vehicle, the data is provided which is associated with a current driver of the motor vehicle.

11. The method according to claim 1, further comprising:
sending additional data to the motor vehicle from at least one additional motor vehicle by means of the communication network; and
providing the received data by means of the information and entertainment system as a function of the classified current traffic situation.

12. The method according to claim 11, wherein the additional data is transmitted by means of a vehicle-to-vehicle communication device.

13. An information and entertainment system for a motor vehicle, comprising:
an input device for the providing of data for a transmission to at least one additional motor vehicle over a communication network;
a determining device that determines at least one parameter characterizing a traffic situation of the motor vehicle;
a classification device that classifies a current traffic situation of the motor vehicle, based on the at least one determined parameter; and
an adaptation device that generates a parameter characterizing an availability of the motor vehicle within the communication network as a function of the classified current traffic situation.

14. A computer program product, comprising:
a non-transitory computer readable medium readable by a processing unit of a motor vehicle and storing instructions for execution by the processing unit for performing a method comprising:
providing data for a transmission to at least one additional motor vehicle by means of a communication network;
determining of at least one parameter characterizing a traffic situation of the motor vehicle;
classifying of a current traffic situation of the motor vehicle, based on the at least one determined parameter; and
adapting of a parameter characterizing an availability of the motor vehicle within the communication network as a function of the classified current traffic situation.

15. The computer program product according to claim 14, wherein the determining of the at least one parameter further comprises:
determining at least one of a type and a condition of a roadway currently travelled by the motor vehicle.

16. The computer program product according to claim 14, wherein the determining of the at least one parameter further comprises:
determining a number of additional road users in the region of the environment of the motor vehicle.

17. The computer program product according to claim 14, wherein the determining of the at least one parameter further comprises:
determining at least one of a current speed and of a current position of the motor vehicle.

18. The computer program product according to claim 14, further comprising:
determining whether at least one additional participant of the communication network is situated in the region of the environment of the motor vehicle; and
issuing a message with the information and entertainment system if the at least one additional participant is determined, the message containing information with respect to the at least one additional participant.

19. The computer program product according to claim 18, further comprising:
querying the at least one additional participant for a transmission of the data; and
transmitting at least a portion of the data to the at least one additional participant, if the additional participant authorizes the transmission.
